(19) United States
(12) Patent Application Publication
(10) Pub. No.: US 2023/0177367 A1
(43) Pub. Date: Jun. 8, 2023

(54) TRAINING OF QUANTUM BOLTZMANN MACHINES BY QUANTUM IMAGINARY-TIME EVOLUTION

(71) Applicant: International Business Machines Corporation, Armonk, NY (US)

(72) Inventors: Antonio Mezzacapo, Westchester, NY (US); Mario Motta, San Jose, CA (US)

(21) Appl. No.: 17/544,314

(22) Filed: Dec. 7, 2021

(51) Int. Cl. G06N 7/00; G06N 10/00

(52) U.S. Cl. CPC G06N 7/005; G06N 10/00

(57) ABSTRACT

Systems, computer-implemented methods, and computer program products to facilitate training of quantum Boltzmann machines by quantum imaginary-time evolution. According to an embodiment, a system can comprise computer executable components stored in memory. The computer executable components comprise an evaluation component that evaluates a Kullback-Leibler divergence gradient by a sampling procedure, where samples are generated by quantum imaginary-time evolution and a Hadamard circuit.

### BACKGROUND

The subject disclosure relates to machine learning, and more specifically to training of quantum Boltzmann machines by quantum imaginary-time evolution.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate training of quantum Boltzmann machines by quantum imaginary-time evolution are described.

According to an embodiment, a system can comprise a processor that executes computer executable components stored in memory. The computer executable components comprise an evaluation component that evaluates a Kullback-Leibler divergence gradient by a sampling procedure, where samples are generated by quantum imaginary-time evolution and a Hadamard circuit.

According to another embodiment, a computer-implemented method can comprise evaluating, by a system operatively coupled to a processor, a Kullback-Leibler divergence gradient by a sampling procedure, where samples are generated by quantum imaginary-time evolution and a Hadamard circuit.

According to another embodiment, a computer program product comprising a computer readable storage medium having program instructions embodied therewith, the program instructions executable by a processor to cause the processor to evaluate, by the processor, a Kullback-Leibler divergence gradient by a sampling procedure, where samples are generated by quantum imaginary-time evolution and a Hadamard circuit.

### DESCRIPTION OF THE DRAWINGS

FIG. 1 illustrates a block diagram of an example, non-limiting system that can complete execution of a quantum job in accordance with one or more embodiments described herein.

FIG. 2 illustrates a block diagram of an example, non-limiting system that can facilitate training of quantum Boltzmann machines by quantum imaginary-time evolution in accordance with one or more embodiments described herein.

FIG. 3 illustrates a block diagram of an example, non-limiting system that can facilitate training of quantum Boltzmann machines by quantum imaginary-time evolution in accordance with one or more embodiments described herein.

FIG. 4A illustrates a flow diagram of an example, non-limiting computer-implemented method that can facilitate evaluation of a Kullback-Leibler divergence in accordance with one or more embodiments described herein.

FIG. 4B illustrates an example, non-limiting diagram of Hadamard test circuit used to facilitate training of a quantum Boltzmann machine in accordance with one or more embodiments described herein.

FIG. 5 illustrates a graph of a training set used to train a Boltzmann machine in accordance with one or more embodiments described herein.

FIG. 6 illustrates a graph of a comparison of a Kullback-Leibler divergence and the norm of its gradient in accordance with one or more embodiments described herein.

FIG. 7 illustrates a graph of the performance of a Boltzmann machine trained in accordance with one or more embodiments described herein.

FIG. 8 illustrates a flow diagram of an example, non-limiting computer-implemented method that can facilitate training of quantum Boltzmann machines by quantum imaginary-time evolution in accordance with one or more embodiments described herein.

FIG. 9 illustrates a flow diagram of an example, non-limiting computer-implemented method that can facilitate training of quantum Boltzmann machines by quantum imaginary-time evolution in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Machine learning is a growing field of computer science, with applications ranging from computer vision and voice recognition to medical diagnosis and message filtering. Machine learning algorithms operate by constructing a model with parameters that can be determined, or learned, from a large amount of example inputs, or training sets, and their empirical probability distribution. If the training process is successful, the trained model can then make accurate predictions about unseen data. The quality of the training process is what determines the accuracy of the predictions made by the trained model.

Recently, there has been growing interest in using quantum computing to perform machine learning. Quantum computing is generally the use of quantum-mechanical phenomena to perform computing and information processing functions. Quantum computing can be viewed in contrast to classical computing, which generally operates on binary values with transistors. That is, while classical computers can operate on bit values that are either 0 or 1, quantum computers operate on quantum bits (qubits) that comprise superpositions of both 0 and 1, which can entangle multiple quantum bits and can use interference. This quantum superposition allows quantum systems to store and represent large data sets that are difficult to represent classically. Quantum computing has the potential to solve problems that, due to computational complexity, cannot be solved or can only be solved slowly on a classical computer.

Due to the advantages qubits have in comparison to classical bits in representing data, quantum machine learning offers potentially greatly increased performance in comparison to classical machine learning. However, a problem with quantum machine learning is creating an effective training process which can enable exact evaluation of the accuracy of the training process, rather than a simple approximation.

Given problems described above with existing quantum machine learning technologies, the present disclosure can be implemented to produce a solution to these problems in the form of systems, computer-implemented methods, and/or computer program products that can facilitate training of quantum Boltzmann machines by quantum imaginary-time evolution by: evaluating a Kullback-Leibler divergence gradient by a sampling procedure, where samples are generated by quantum imaginary-time evolution and a Hadamard circuit. In some embodiments, the present disclosure can be implemented to produce a solution to the problems in the form of systems, computer-implemented methods, and/or computer program products that can facilitate training of quantum Boltzmann machines by quantum imaginary-time evolution by: evaluating a Kullback-Leibler divergence hessian by a sampling procedure, where samples are generated by quantum imaginary-time evolution and a Hadamard circuit.

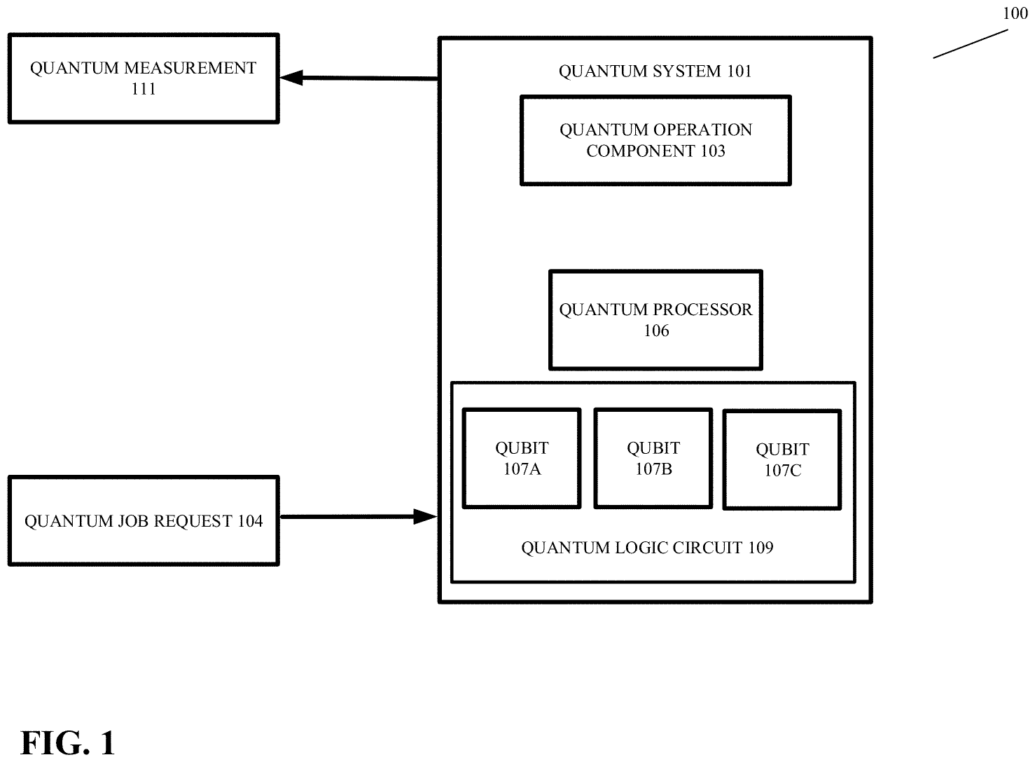

Turning first generally to FIG. 1, one or more embodiments described herein can include one or more devices, systems and/or apparatuses that can facilitate executing one or more quantum operations to facilitate output of one or more quantum results. For example, FIG. 1 illustrates a block diagram of an example, non-limiting system 100 that can complete the execution of a quantum job.

The quantum system 101 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement 111, can be responsive to the quantum job request 104 and associated input data and can be based at least in part on the input data, quantum functions and/or quantum computations.

In one or more embodiments, the quantum system 101 can comprise one or more quantum components, such as a quantum operation component 103, a quantum processor 106 and a quantum logic circuit 109 comprising one or more qubits (e.g., qubits 107A, 107B and/or 107C), also referred to herein as qubit devices 107A, 107B and 107C. The quantum processor 106 can be any suitable processor, such as being capable of controlling qubit coherence and the like. The quantum processor 106 can generate one or more instructions for controlling the one or more processes of the quantum operation component 103.

The quantum operation component 103 that can obtain (e.g., download, receive, search for and/or the like) a quantum job request 104 requesting execution of one or more quantum programs. The quantum operation component 103 can determine one or more quantum logic circuits, such as the quantum logic circuit 109, for executing the quantum program. The request 104 can be provided in any suitable format, such as a text format, binary format and/or another suitable format. In one or more embodiments, the request 104 can be received by a component other than a component of the quantum system 101, such as a by a component of a classical system coupled to and/or in communication with the quantum system 101.

The quantum operation component 103 can perform one or more quantum processes, calculations and/or measurements for operating one or more quantum circuits on the one or more qubits 107A, 107B and/or 107C. For example, the quantum operation component 103 can operate one or more qubit effectors, such as qubit oscillators, harmonic oscillators, pulse generators and/or the like to cause one or more pulses to stimulate and/or manipulate the state(s) of the one or more qubits 107A, 107B and/or 107C comprised by the quantum system 101. That is, the quantum operation component 103, such as in combination with the quantum processor 106, can execute operation of a quantum logic circuit on one or more qubits of the circuit (e.g., qubit 107A, 107B and/or 107C). The quantum operation component 103 can output one or more quantum job results, such as one or more quantum measurements 111, in response to the quantum job request 104.

It will be appreciated that the following description(s) refer(s) to the operation of a single quantum program from a single quantum job request. However, it also will be appreciated that one or more of the processes described herein can be scalable, such as execution of one or more quantum programs and/or quantum job requests in parallel with one another.

In one or more embodiments, the non-limiting system 100 can be a hybrid system and thus can include both one or more classical systems, such as a quantum program implementation system, and one or more quantum systems, such as the quantum system 101. In one or more other embodiments, the quantum system 101 can be separate from, but function in combination with, a classical system.

In such case, one or more communications between one or more components of the non-limiting system 100 and a classical system can be facilitated by wired and/or wireless means including, but not limited to, employing a cellular network, a wide area network (WAN) (e.g., the Internet), and/or a local area network (LAN). Suitable wired or wireless technologies for facilitating the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an ANT, an ultra-wideband (UWB) standard protocol and/or other proprietary and/or non-proprietary communication protocols.

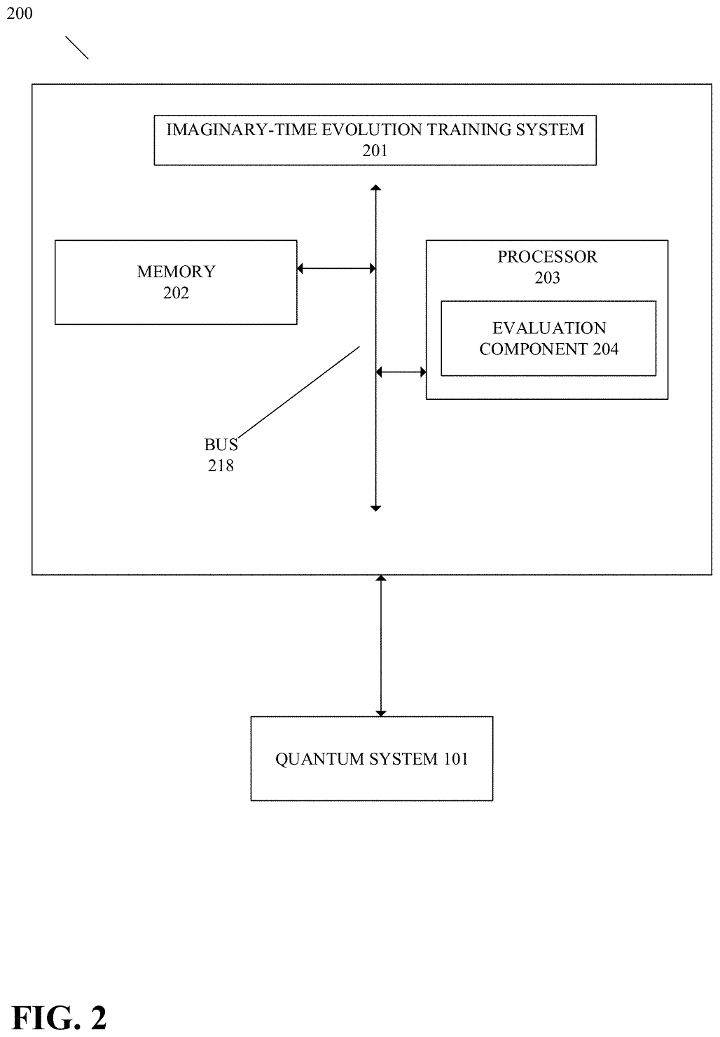

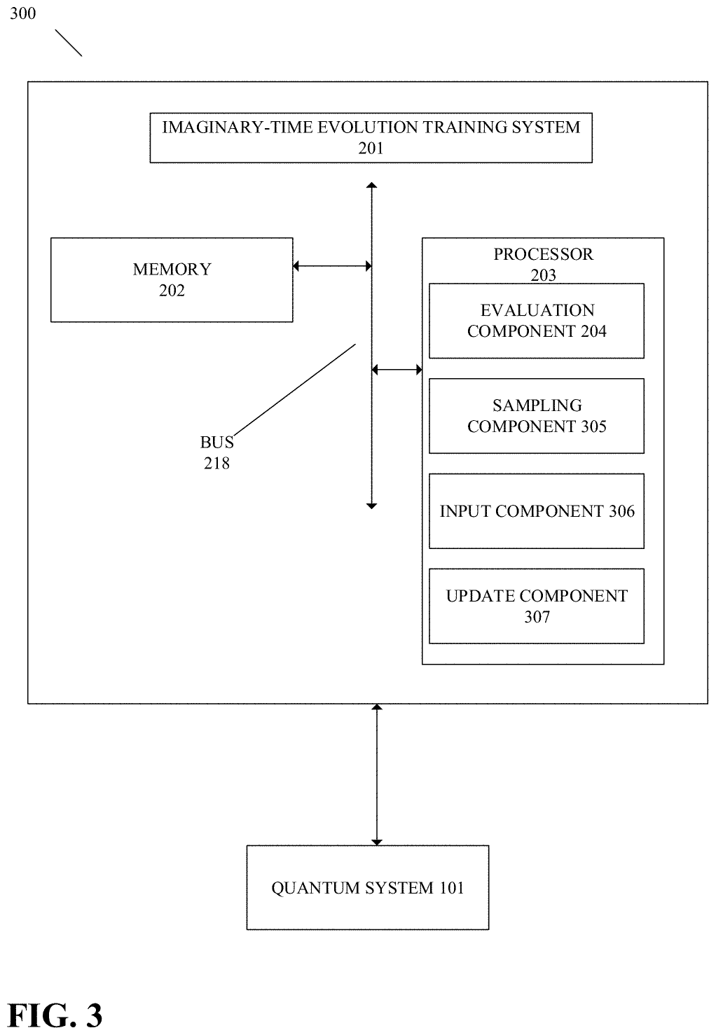

FIGS. 2 and 3 illustrate block diagrams of example, non-limiting systems 200 and 300 that can facilitate training of quantum Boltzmann machines by quantum imaginary-time evolution. System 200 and 300 can each comprise imaginary-time evolution training system 201. Imaginary-time evolution training system 201 of systems 200 and 300 can each comprise a memory 202, a processor 203, an evaluation component 204, a quantum system 101, and/or a bus 218. Imaginary-time evolution training system 201 of system 300 depicted in FIG. 3 can further comprise a sampling component 305, an input component 306, and/or an update component 307.

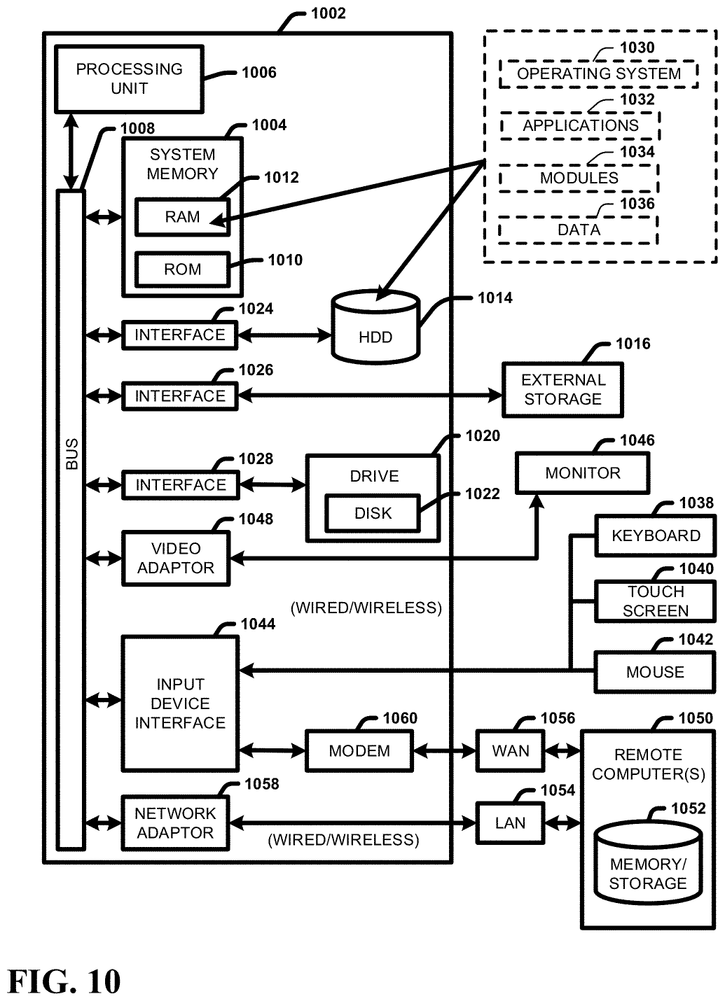

It should be appreciated that the embodiments of the subject disclosure depicted in various figures disclosed herein are for illustration only, and as such, the architecture of such embodiments are not limited to the systems, devices, and/or components depicted therein. For example, in some embodiments, system 200, system 300 and/or imaginary-time evolution training system 201 can further comprise various computer and/or computing-based elements described herein with reference to operating environment 1000 and FIG. 10. In several embodiments, such computer and/or computing-based elements can be used in connection with implementing one or more of the systems, devices, components, and/or computer-implemented operations shown and described in connection with FIGS. 1, 2, 3, and/or other figures disclosed herein.

Memory 202 can store one or more computer and/or machine readable, writable, and/or executable components and/or instructions that, when executed by processor 203 (e.g., a classical processor, a quantum processor, and/or another type of processor), can facilitate performance of operations defined by the executable component(s) and/or instruction(s). For example, memory 202 can store computer and/or machine readable, writable, and/or executable components and/or instructions that, when executed by processor 203, can facilitate execution of the various functions described herein relating to imaginary-time evolution training system 201, evaluation component 204, sampling component 305, input component 306, update component 307, and/or another component associated with imaginary-time evolution training system 201.

Memory 202 can comprise volatile memory (e.g., random access memory (RAM), static RAM (SRAM), dynamic RAM (DRAM), and/or another type of volatile memory) and/or non-volatile memory (e.g., read only memory (ROM), programmable ROM (PROM), electrically programmable ROM (EPROM), electrically erasable programmable ROM (EEPROM), and/or another type of non-volatile memory) that can employ one or more memory architectures. Further examples of memory 202 are described below with reference to system memory 1016 and FIG. 10. Such examples of memory 202 can be employed to implement any embodiments of the subject disclosure.

Processor 203 can comprise one or more types of processors and/or electronic circuitry (e.g., a classical processor, a quantum processor, and/or another type of processor and/or electronic circuitry) that can implement one or more computer and/or machine readable, writable, and/or executable components and/or instructions that can be stored on memory 202. For example, processor 203 can perform various operations that can be specified by such computer and/or machine readable, writable, and/or executable components and/or instructions including, but not limited to, logic, control, input/output (I/O), arithmetic, and/or the like. In some embodiments, processor 203 can comprise one or more central processing unit, multi-core processor, microprocessor, dual microprocessors, microcontroller, System on a Chip (SOC), array processor, vector processor, quantum processor, and/or another type of processor. Further examples of processor 203 are described below with reference to processing unit 1004 and FIG. 10. Such examples of processor 203 can be employed to implement any embodiments of the subject disclosure.

Imaginary-time evolution training system 201, memory 202, processor 203, evaluation component 204, sampling component 305, input component 306, update component 307, quantum system 101, and/or another component of imaginary-time evolution training system 201 as described herein can be communicatively, electrically, operatively, and/or optically coupled to one another via bus 218 to perform functions of system 200, system 300, imaginary-time evolution training system 201, and/or any components coupled therewith. Bus 218 can comprise one or more memory bus, memory controller, peripheral bus, external bus, local bus, a quantum bus, and/or another type of bus that can employ various bus architectures. Further examples of bus 218 are described below with reference to system bus 1008 and FIG. 10. Such examples of bus 218 can be employed to implement any embodiments of the subject disclosure.

Imaginary-time evolution training system 201 can comprise any type of component, machine device, facility, apparatus, and/or instrument that comprises a processor and/or can be capable of effective and/or operative communication with a wired and/or wireless network. All such embodiments are envisioned. For example, imaginary-time evolution training system 201 can comprise a server device, a computing device, a general-purpose computer, a special-purpose computer, a quantum computing device (e.g., a quantum computer), a tablet computing device, a handheld device, a server class computing machine and/or database, a laptop computer, a notebook computer, a desktop computer, a cell phone, a smart phone, a consumer appliance and/or instrumentation, an industrial and/or commercial device, a digital assistant, a multimedia Internet enabled phone, a multimedia players, and/or another type of device.

Imaginary-time evolution training system 201 can be coupled (e.g., communicatively, electrically, operatively, optically, and/or coupled via another type of coupling) to one or more external systems, sources, and/or devices (e.g., classical and/or quantum computing devices, communication devices, and/or another type of external system, source, and/or device) using a wire and/or a cable. For example, imaginary-time evolution training system 201 can be coupled (e.g., communicatively, electrically, operatively, optically, and/or coupled via another type of coupling) to one or more external systems, sources, and/or devices (e.g., classical and/or quantum computing devices, communication devices, and/or another type of external system, source, and/or device) using a data cable including, but not limited to, a High-Definition Multimedia Interface (HDMI) cable, a recommended standard (RS) 232 cable, an Ethernet cable, and/or another data cable.

In some embodiments, imaginary-time evolution training system 201 can be coupled (e.g., communicatively, electrically, operatively, optically, and/or coupled via another type of coupling) to one or more external systems, sources, and/or devices (e.g., classical and/or quantum computing devices, communication devices, and/or another type of external system, source, and/or device) via a network. For example, such a network can comprise wired and/or wireless networks, including, but not limited to, a cellular network, a wide area network (WAN) (e.g., the Internet) or a local area network (LAN). Imaginary-time evolution training system 201 201 can communicate with one or more external systems, sources, and/or devices, for instance, computing devices using virtually any desired wired and/or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol, and/or other proprietary and non-proprietary communication protocols. Therefore, in some embodiments, imaginary-time evolution training system 201 can comprise hardware (e.g., a central processing unit (CPU), a transceiver, a decoder, quantum hardware, a quantum processor, and/or other hardware), software (e.g., a set of threads, a set of processes, software in execution, quantum pulse schedule, quantum circuit, quantum gates, and/or other software) or a combination of hardware and software that can facilitate communicating information between imaginary-time evolution training system 201 and external systems, sources, and/or devices (e.g., computing devices, communication devices, and/or another type of external system, source, and/or device).

Imaginary-time evolution training system 201 can comprise one or more computer and/or machine readable, writable, and/or executable components and/or instructions that, when executed by the processor 203 (e.g., a classical processor, a quantum processor, and/or another type of processor), can facilitate performance of operations defined by such component(s) and/or instruction(s). Further, in numerous embodiments, any component associated with imaginary-time evolution training system 201, as described herein with or without references to the various figures of the subject disclosure, can comprise one or more computer and/or machine readable, writable, and/or executable components and/or instructions that, when executed by processor 203, can facilitate performance of operations defined by such component(s) and/or instruction(s). For example, evaluation component 204, sampling component 305, input component 306, update component 307, quantum system 101, and/or any other components associated with imaginary-time evolution training system 201 as disclosed herein (e.g., communicatively, electronically, operatively, and/or optically coupled with and/or employed by imaginary-time evolution training system 201), can comprise such computer and/or machine readable, writable, and/or executable component(s) and/or instruction(s). Consequently, according to numerous embodiments, imaginary-time evolution training system 201 and/or components associated therewith as disclosed herein, can employ processor 203 to execute such computer and/or machine readable, writable, and/or executable component(s) and/or instruction(s) to facilitate performance of one or more operations described herein with reference to imaginary-time evolution training system 201 and/or any such components associated therewith.

Imaginary-time evolution training system 201 can facilitate (e.g., via processor 203) performance of operations executed by and/or associated with evaluation component 204, sampling component 305, input component 306, update component 307, quantum system 101, and/or another component associated with imaginary-time evolution training system 201 as disclosed herein. For example, as described in detail below, imaginary-time evolution training system 201 can facilitate (e.g., via processor 203): evaluating a Kullback-Leibler divergence gradient by a sampling procedure, where samples are generated by quantum imaginary-time evolution and a Hadamard circuit.

Evaluation component 204 can evaluate a Kullback-Leibler divergence gradient by a sampling procedure, where samples are generated by quantum imaginary-time evolution and a Hadamard circuit. For example, a Boltzmann machine operates by having visible variables, which comprise a training set and an empirical probability distribution, and hidden variables which are used to generate an approximation of the empirical probability distribution. The accuracy of the Boltzmann machine can then be determined by calculating the Kullback-Leibler divergence between the empirical probability distribution and the approximation of the probability distribution. The approximation of the probability distribution can be determined through the use of sampling the visible and hidden variables. As such, a minimization of the Kullback-Leibler divergence will lead to a Boltzmann system with high accuracy. A quantum Boltzmann machine can be produced using two qubit registers, such as from quantum system 101, one with visible spins, and one with hidden spins. In an embodiment, the qubit registers can be prepared on a quantum simulator as opposed to quantum hardware. The visible register can be used as the training set, while the hidden register can be used to approximate the empirical probability distribution. As such, the training process of the Boltzmann machine with a an Ising Hamiltonian acting on a set of visible and hidden spins is augmented with a transverse field can be defined as P_{λ}(ν)=Tr[|ν [symbol] [symbol] ν|⊕Ie^{-H}^{_{λ}}]/Tr[e^{-H}^{_{λ}}], wherein λ is a parameter configuration, H_{λ} is a Hamiltonian of the system with the parameter configuration, ν are samples from the empirical probability distribution, and e^{-H}^{_{λ}} is the thermal equilibrium state the H_{λ}. In an embodiment, the equilibrium state e^{-H}^{_{λ}} can be achieved using a quantum imaginary-time evolution cooling process. For example, an imaginary-time evolution wave function |Ψ [symbol] can be mapped onto a sequence of unitary transformations to produce |Ψ [symbol] →e^{-H}^{_{λ}}|Ψ [symbol] . Put another way, the trained model can be defined as

$${P}_{λ} ( h ) = \frac{{\sum }_{h} 〈 v , h \vert {e}^{- {H}_{λ}} \vert v , h 〉}{{\sum }_{w h} 〈 w , h \vert {e}^{- {H}_{λ}} \vert w , h 〉}$$

where h is a sample from the hidden register and w is a dummy integration variable, that lies in the same set as the variable ν.

The accuracy of the training process P_{λ}(ν) can be measured by the Kullback-Leibler divergence D (Q (ν), P_{λ}(ν)). In an embodiment, D (Q (ν), P_{λ}(ν)) can be calculated as the thermal averaging, E which can be evaluated by a quantum imaginary-time evolution process. For example, the thermal averages involving |ν [symbol] [symbol] ν| can be determined using a sampling of the empirical probability distribution ν, propagating |ν, h [symbol] in imaginary time using a quantum imaginary-time evolution process, and using a Hadamard test for evaluating expectation values of non-Hermitian operators. For example, evaluation component 206 can evaluate the Kullback-Leibler divergence gradient as

$${\partial }_{{λ}^{μ}} D ( λ ) = E [ {\partial }_{{λ}^{μ}} {H}_{λ} ] - {\int }_{0}^{1} d x {\sum }_{v} Q ( v ) \frac{E [ ( \vert v 〉 〈 v \vert ⊗ I ) {e}^{- x {H}_{λ}} {\partial }_{{λ}^{μ}} {H}_{λ} {e}^{( x - 1 ) {H}_{λ}} ]}{E [ ( \vert v 〉 〈 v \vert ⊗ I ) {e}^{- {H}_{λ}} ]}$$

wherein E denotes thermal averaging, λ denotes the parameter configuration, ν is a visible sample state, x is a sample of a dummy integration variable, h is a hidden sample state, and H_{λ} denotes a Hamiltonian with parameters λ. In the above equation E [∂_{λ}_{^{μ}}H_{λ}] is the thermal averaging of the gradient of the Hamiltonian and its parameter configuration, ∂_{λ}_{^{μ}}H_{λ} is the application of the Hamiltonian, e^{-xH}^{_{λ}} is a cooling phase of the qubit registers of quantum system 101, and e^{(x-1)H}^{_{λ}} is a warming phase of the qubit registers of quantum system 101. In this embodiment, a Hadamard test circuit with the unitaries Uₓ and U₁₋ₓ, performed by quantum system 101, can be used to evaluate the Kullback-Leibler divergence. In another embodiment, the Hadamard test circuit can be performed by a quantum simulator as opposed to quantum hardware. For example, Ux|ν, h) can be determined using by the Hadamard test circuit performing the following equation:

$$\frac{{e}^{- x {H}_{λ}} \vert v , h 〉}{\vert {e}^{- x {H}_{λ}} \vert v , h 〉 \vert} = {U}_{x} \vert v , h 〉$$

wherein the cooling process to calculate e^{-xH}^{_{λ}} can be performed using an imaginary-time evolution. Using the Hadamard circuit, the gradient of the Hamiltonian and its parameters can be calculated as

∂_{λ}_{^{μ}}H_{λ}=h_{μ}

Additionally, the Hadamard circuit can be used to perform the equation:

$$〈 {σ}_{-} ⊗ {h}_{μ} 〉 = 〈 v , h \vert {U}_{x}^{*} {h}_{μ} {U}_{1 - x} \vert v , h 〉 = \frac{〈 v , h \vert {e}^{- {xH}_{λ}} {\partial }_{{λ}^{μ}} {He}^{- ( 1 - x ) {H}_{λ}} \vert v , h 〉}{\vert {e}^{- {xH}_{λ}} \vert v , h 〉 \vert \vert {e}^{- ( 1 - x ) {H}_{λ}} \vert v , h 〉 \vert}$$

which contains two quantum imaginary-time evolutions performed using the unitaries Uₓ and U₁₋ₓ. It should be appreciated that both of these quantum imaginary-time evolutions are controlled by the sample x but produce different outcomes. Using these values, evaluation component 206 can compute the gradient of the Kullback-Leibler divergence using the definition formula of the gradient as described above.

As such, evaluation component 206 can request the value of the H_{λ} from quantum system 101, signal quantum system 101 to propagate |ν,h [symbol] in imaginary time using a quantum imaginary-time evolution, and signal quantum system 101 to perform cooling process e^{-xH}^{_{λ}} and warming process e(x⁻¹)^{H}^{_{λ}}. It should be appreciated that as the warming and cooling phases are controlled by the variable of the integral, x. Evaluation component 206 can also signal quantum system 101 to evaluate the expectation values of non-Hermitian operators and return the results. Evaluation component 206 can then compute the gradient using the above defined formula and the values received from quantum system 101. In an embodiment, the functions performed by quantum system 101 can be performed by a quantum simulator as opposed to quantum hardware.

Calculating the Kullback-Leibler divergence gradient is polynomially expensive, while evaluating Kullback-Leibler divergence is exponentially expensive. As such evaluation can be optimized with an optimization scheme such as Conjugate-Gradient, Broyden-Fletcher-Goldfarb-Shanno—where, during the line-search phases, Kullback-Leibler divergence differences are evaluated at polynomial cost as D(λ+gt)−D(λ)=∫₀^{t}ds g^{μ}∂_{λ}_{^{μ}}D(λ+gs).

In another embodiment, rather than evaluating the accuracy of the training process using a Kullback-Leibler divergence gradient, evaluation component 206 can evaluate a Kullback-Leibler divergence hessian. The Kullback-Leibler divergence hessian may be more appropriate for more sophisticated models or optimization schemes such as the Newton-Raphson method. In an embodiment, evaluation component 206 can evaluate the Kullback-Leibler divergence hessian as

∂_{λ}_{^{ρ}}_{λ}_{^{μ}}D(λ)=E[h_{ρ}]E[h_{μ}]−∫₀¹dxE[h_{ρ}(x)h_{μ}]+∫₀¹dx∫₀¹dyΣ_{ν}Q(ν){E_{ν}[h_{ρ}(xy)h_{μ}(x)]−x E_{ν}[h_{μ}(x)]E_{ν}[h_{ρ}(y)]},

wherein E denotes thermal averaging, λ denotes the parameter configuration, ν is a visible sample state, x is a dummy integration variable, h is a hidden sample state, state, y is a second dummy integration variable, H_{λ} denotes a Hamiltonian, and

$${E}_{v} [ X ] = \frac{E [ ( \vert v 〉 ( v \vert ⊗ I ) {Xe}^{- {H}_{λ}} ]}{E [ ( \vert v 〉 ( v \vert ⊗ I ) {e}^{- {H}_{λ}} ]} .$$

Evaluation component 206 can then evaluate the hessian in the same manner as described above in reference to the gradient.

Input component 306 can input a Hamiltonian parameter configuration into a quantum imaginary-time evolution and Hadamard circuit. For example, input component 306 can receive as input from a user an initial Hamiltonian and an initial parameter configuration for the Hamiltonian. In an embodiment, the Hamiltonian can be an operator corresponding to the total energy of quantum system 101. The parameters, such as angles of single qubit rotations, can be adjusted to change the expectation energy of the Hamiltonian. In an embodiment, a set of parameters can be input to the input component by a user. In another embodiment, input component 306 can select a set of parameters from memory. For example, a set of parameters may be set as an initial default set, and input component 306 can select the initial default set as the parameters for a first iteration of the training process. In a further embodiment, as described in detail below, input component 306 can receive a set of parameters from update component 307. Input component 306 can then signal quantum system 101 to prepare two registers of qubits in the thermal equilibrium state of the Hamiltonian and the parameter configuration, H. In an embodiment, one of the qubit registers can be a visible register with visible spins of the qubits in the register and the other can be a hidden register with hidden spins of the qubits in the registers. This enables quantum system 101 to operate as a Boltzmann machine as the visible register can represent the visible data used in Boltzmann machines as a training set and empirical probability of distribution of the training set. The hidden register can then be used to approximate the empirical probability distribution.

Sampling component 305 can sample states produced by quantum imaginary-time evolution and a Hadamard circuit, and their contribution to the Kullback-Leibler divergence. In an embodiment, sampling component 305 can take three samples, v, x, and h, wherein ν is a visible sample state, x, is sample of a dummy integration variable, and h is a hidden sample state. For example, ν can be a sample from Q(ν), the empirical probability distribution, that can be sampled using a metropolis algorithm. X can be taken from the x variable which controls the integral in the formulation of the Kullback-Leibler gradient described above. H can be sampled from P_{λ}(h), as defined above as the trained model or the approximated probability distribution. In an embodiment, these samples can be taken through the use of a random sampling process. In an embodiment, sampling component 305 can provide these samples to evaluation component 204 to be used as part of the evaluation process described in detail above. It should be appreciated that as ν is sampled from the empirical probability distribution and h is sampled from the approximated probability distribution, the comparison between these two distributions, the Kullback-Leibler divergence, serves as a measure of accuracy of the training process.

Update component 307 can update the Hamiltonian parameter configuration to minimize the Kullback-Leibler divergence. For example, update component 307 can receive an intended accuracy value that is an intended Kullback-Leibler divergence value. If the Kullback-Leibler divergence value generated by evaluation component 204 is above the Kullback-Leibler divergence value, then the actual accuracy is below the intended accuracy value. Update component 307 can then update the parameter set used by input component 306 in order to decrease the Kullback-Leibler divergence value evaluated by the evaluation component. In an embodiment, update component 307 can use a statistical sample from the Kullback-Leibler divergence. In order to achieve this optimization, update component 307 can use the definition of the Kullback-Leibler divergence gradient, or hessian, described above as a cost function. Update component 307 can then use a classical optimization technique such as batch gradient descent, stochastic gradient descent, mini-batch gradient descent, or any other optimization technique applicable with a cost function. Examples of optimization algorithms update component 307 can use include Adam, RMSprop, Adagrad, or another applicable algorithm. Once update component 307 has selected a new parameter configuration for the Hamiltonian, update component 307 can signal input component 306 to prepare new registers of qubits using the Hamiltonian and the new parameter configuration.

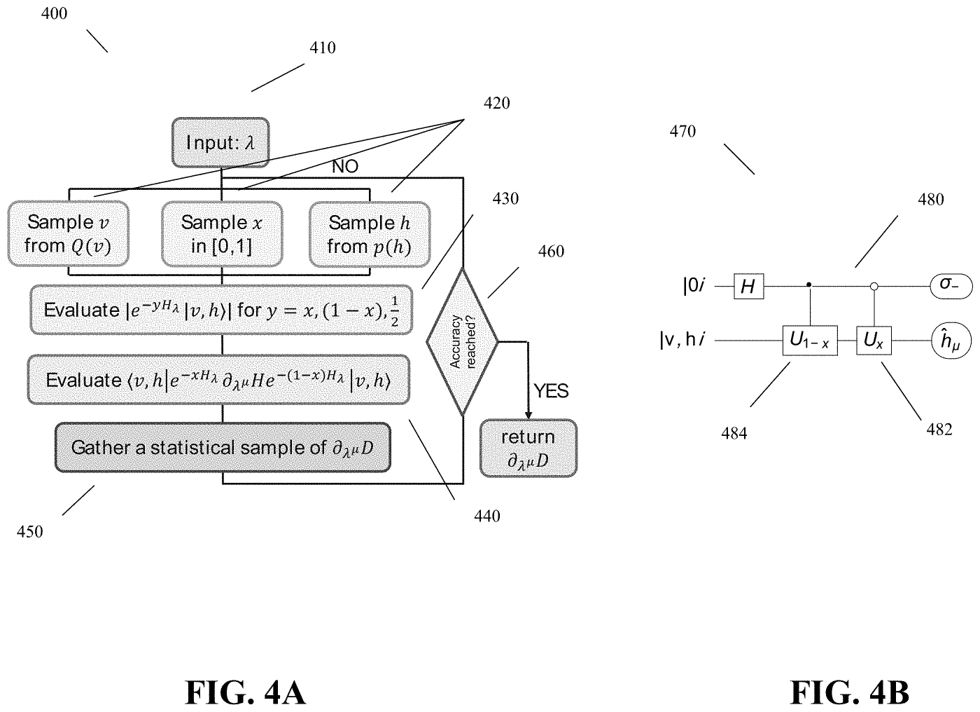

FIG. 4A illustrates a flow diagram of an example, non-limiting computer-implemented method 400 that can facilitate evaluation of a Kullback-Leibler divergence in accordance with one or more embodiments described herein. Repetitive description of like elements employed in respective embodiments is omitted for sake of brevity.

At 410, computer-implemented method 400 can comprise inputting, by a system (e.g., imaginary-time evolution training system 201 and/or input component 306) operatively coupled to a processor (e.g., processor 203), parameters of a Hamiltonian.

At 420, computer-implemented method 400 can comprise sampling, by the system (e.g., imaginary-time evolution training system 201 and/or sampling component 305) a visible configuration ν, from the empirical probability distribution from a training set Q(ν), a dummy integration variable x in [0,1], and a hidden configuration h from the trained model P_{λ}(h). For example, as described above in reference to FIG. 2, these samples can be taken by a random sampling process that samples a random number of data points from the respective probability distributions.

At 430, computer-implemented method 400 can comprise performing, by the system (e.g., imaginary-time evolution training system 201, evaluation component 204, and/or quantum system 101), a first portion of a calculation to evaluate the Kullback-Leibler divergence. For example, evaluation component 204 can evaluate |e^{-yH}^{_{λ}}|ν,h [symbol] | for y=x, (1-x), ½. In an embodiment, evaluation component 204 can signal quantum system 101 to perform this evaluation, and in a further embodiment, quantum system 101 can employ a Hadamard circuit to assist in the evaluation.

At 440, computer-implemented method 400 can comprise performing, by the system (e.g., imaginary-time evolution training system 201, evaluation component 204, and/or quantum system 101), a second portion of a calculation to evaluate the Kullback-Leibler divergence. For example, evaluation component 204 can evaluate [symbol] ν, h|e^{-xH}^{_{λ}}∂_{λ}_{^{μ}}H_{λ}e^{(x-1)H}^{_{λ}}|ν,h [symbol] . Using the first portion of the evaluation and the second portion of the evaluation, evaluation component 204 can determine the Kullback-Leibler divergence using the above described formula definition. In an embodiment, evaluation component 204 can signal quantum system 101 to perform this evaluation, and in a further embodiment, quantum system 101 can employ a Hadamard circuit to assist in the evaluation.

At 450, computer-implemented method 400 can comprise gathering, by the system (e.g., imaginary-time evolution training system 201 and/or update component 307), a statistical sample of the Kullback-Leibler divergence.

At 460, computer-implemented method 400 can comprise determining, by the system (e.g., imaginary-time evolution training system 201 and/or update component 307), whether a target accuracy for the training process has been reached. For example, as described above, a the Kullback-Leibler divergence can be used as a measurement of the accuracy of the training of a Boltzmann machine. As such, update component 307 can compare the statistical sample of the Kullback-Leibler divergence to an intended the Kullback-Leibler divergence value. If the value from the statistical sample is less than or equal to the intended value, then the intended accuracy of training has been reached, and update component 307 can signal that training is complete. If the value from the statistical sample is greater than the intended value, then update component 307 can determine an update parameter set using an optimization method as described above in reference to FIG. 3. Update component 307 can then signal input component 306 to begin a new iteration of the training process using the new parameter set.

FIG. 4B illustrates an example, non-limiting diagram 470 of Hadamard test circuit used to facilitate training of a quantum Boltzmann machine in accordance with one or more embodiments described herein.

Diagram 470 comprises Hadamard test circuit 480. As shown, Hadamard test circuit 480 can receive as inputs samples ν and h. Hadamard test circuit 480 as shown comprises unitary gates Uₓ and U₁₋ₓ. As described above with reference to FIGS. 2 and 3, unitary gates Uₓ and U₁₋ₓ can be used to perform quantum imaginary-time evolutions as part of a cooling process, wherein the temperature is controlled by the value of the sample x.

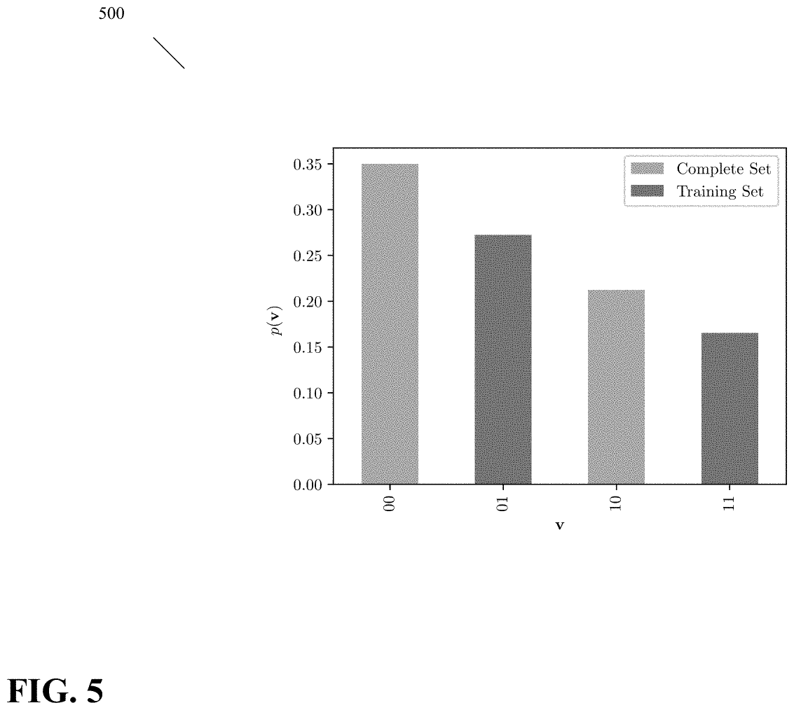

FIGS. 5-7 illustrate graphs representing data related to an application of training a quantum Boltzmann machine to learn a 2-qubit distribution, with a training set of 2 configurations, qubit states |01 [symbol] and |11 [symbol] .

FIG. 5 illustrates a graph 500 of a training set used to train a Boltzmann machine in accordance with one or more embodiments described herein. The y-axis of graph 500 shows the probability of a qubit state occurring and the x-axis shows visible samples ν. There are four visible samples, representing the four possible qubit states |00 [symbol] , |10 [symbol] , |01 [symbol] , and |11 [symbol] . The sample in blue represents the training set, while the green samples represent portions of the complete set that are excluded from the training set. As shown, the qubit states of |01 [symbol] and |11 [symbol] are shown in blue and the quantum Boltzmann machine is trained to determine the probability distribution between these two states. It should be noted that the state |01 [symbol] has a higher probability than state |11 [symbol] according to this training set.

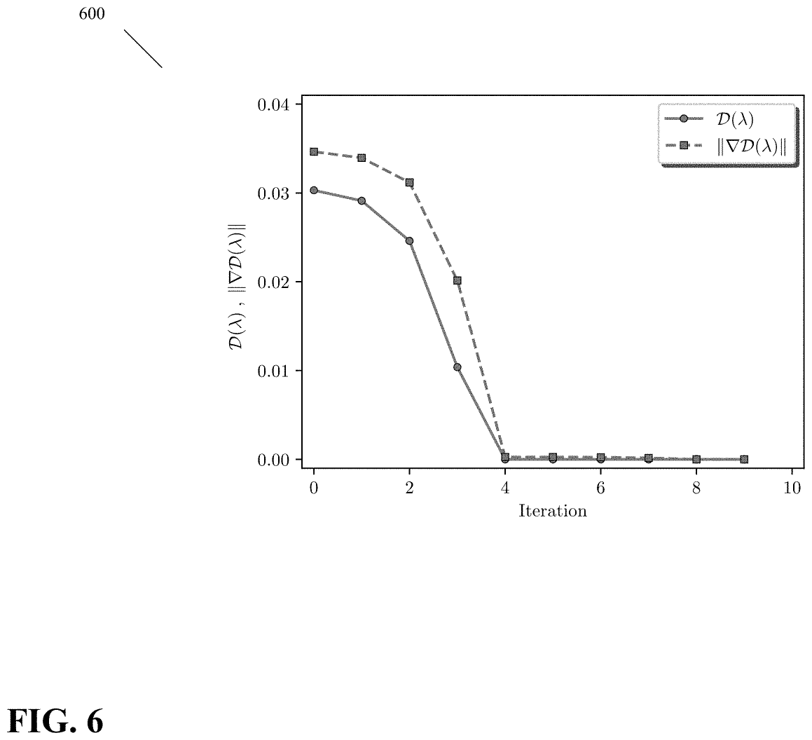

FIG. 6 illustrates a graph 600 of a comparison of a Kullback-Leibler divergence and the norm of its gradient in accordance with one or more embodiments described herein. The y-axis of graph 600 represents the value of a Kullback-Leibler divergence and the norm of its gradient, while the x-axis represents the number of iterations used in the training process. The red line represents the Kullback-Leibler divergence as evaluated using the procedure described in this embodiment, while the blue line shows the norm of a Kullback-Leibler divergence gradient as used in existing training methods. As shown, the red and blue lines both converge to a value near 0 by iteration 4, showing the effectiveness of the evaluation of the Kullback-Leibler divergence as a training process.

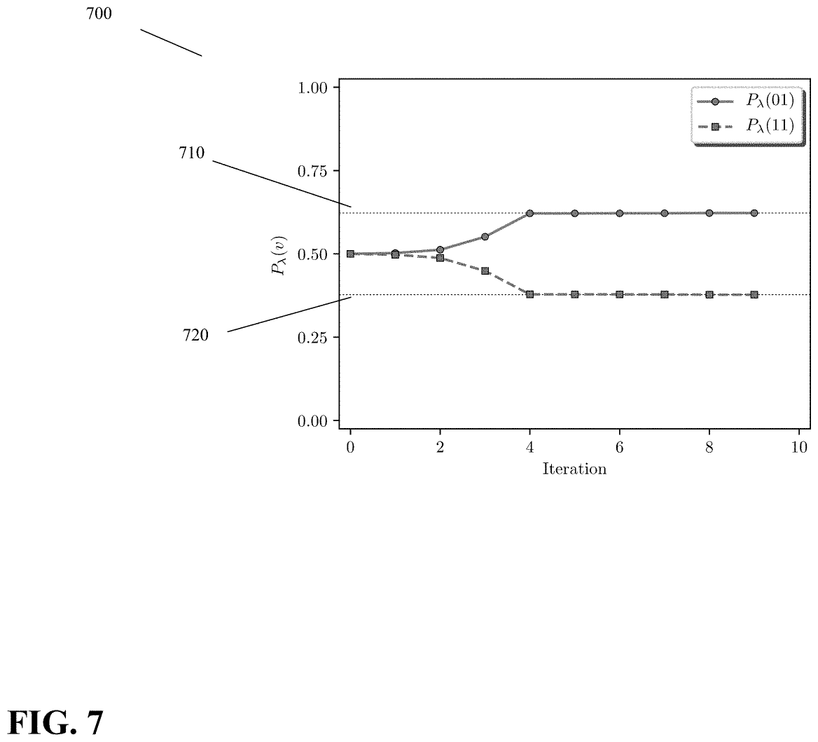

FIG. 7 illustrates a graph 700 of the performance of a Boltzmann machine trained in accordance with one or more embodiments described herein. The y-axis of graph 700 shows the trained probability distribution of a quantum Boltzmann machine while the x-axis shows the number of iterations as part of the training process. Graph 700 comprises upper dotted line 710, which shows the empirical probability distribution of qubit state |01 [symbol] in comparison to qubit state |11 [symbol] and lower dotted line 720, which shows the probability distribution of qubit state |11 [symbol] in comparison to qubit state |01 [symbol] . Graph 700 additionally comprises a red line, which represents the learned probability distribution of qubit state |01 [symbol] in comparison to qubit state |11 [symbol] and a blue line that represents the learned probability distribution of qubit state |11 [symbol] in comparison to qubit state |01 [symbol] . As shown, the blue and red line are both at a probability of 0.50 or 50% at iteration 0, as the Boltzmann machine has not been trained. As the quantum Boltzmann machine is trained, the red line moves towards dotted line 710 and the blue line moves towards lower dotted line 720, showing that the learned probability distributions of the quantum Boltzmann machine move closer to the empirical probability distributions as it is trained. It should be appreciated that in this experiment, the learned probability distributions attain the accuracy of the empirical probability distributions at training iteration 4.

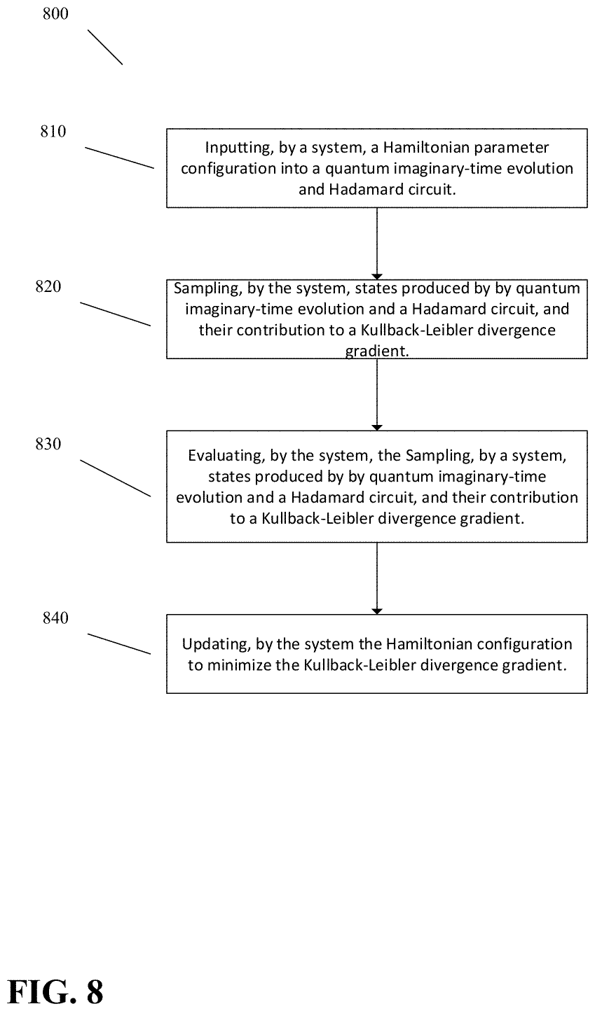

FIG. 8 illustrates a flow diagram of an example, non-limiting computer-implemented method 800 that can facilitate training of quantum Boltzmann machines by quantum imaginary-time evolution in accordance with one or more embodiments described herein.

At 810, computer-implemented method 800 can comprise inputting, by a system (e.g., imaginary-time evolution training system 201 and/or input component 306) operatively coupled to a processor (e.g., processor 203), a Hamiltonian parameter configuration into a quantum imaginary time-evolution and a Hadamard circuit. For example, as described above in reference to FIGS. 2 and 3, input component 306 can receive a Hamiltonian and a set of input parameters. Input component 306 can then signal quantum system 101 to prepare two qubit registers using the equilibrium state of the parameterized Hamiltonian and to prepare a Hadamard circuit to use to perform imaginary-time evolutions. In an embodiment, a quantum simulator can be used to perform the functions of quantum system 101.

At 820, computer-implemented method 800 can comprise sampling, by the system (e.g., imaginary-time evolution training system 201 and/or sampling component 305), states produced by quantum imaginary-time evolution and a Hadamard circuit, and their contribution to a Kullback-Leibler divergence. For example, as described in reference to FIGS. 2 and 3, sampling component 305 can take three samples, ν, x, and h, wherein ν is a visible sample state taken from the training set, x, is sample of a dummy integration variable, and h is a hidden sample state taken from the trained model.

At 830, computer-implemented method 800 can comprise evaluating, by the system (e.g., imaginary-time evolution training system 201 and/or evaluation component 204), the sampling produced by quantum imaginary-time evolution and a Hadamard circuit, and their contribution to the Kullback-Leibler divergence gradient. For example, as described in detail in reference to FIGS. 2 and 3, evaluation component 204 can evaluate the Kullback-Leibler divergence gradient using the formula:

$${\partial }_{{λ}^{μ}} D ( λ ) = E [ {\partial }_{{λ}^{μ}} {H}_{λ} ] - {\int }_{0}^{1} d x {\sum }_{v} Q ( v ) \frac{E [ ( \vert v 〉 〈 v \vert ⊗ I ) {e}^{- x {H}_{λ}} {\partial }_{{λ}^{μ}} {H}_{λ} {e}^{( x - 1 ) {H}_{λ}} ]}{E [ ( \vert v 〉 〈 v \vert ⊗ I ) {e}^{- {H}_{λ}} ]}$$

wherein E denotes thermal averaging, λ denotes the parameter configuration, ν is a visible sample state, x is a sample of a dummy integration variable, h is a hidden sample state, and H_{λ} denotes a Hamiltonian with parameters λ.

At 840, computer-implemented method 800 can comprise updating, by the system (e.g., imaginary-time evolution training system 201 and/or update component 307), the Hamiltonian configuration to minimize the Kullback-Leibler divergence gradient.

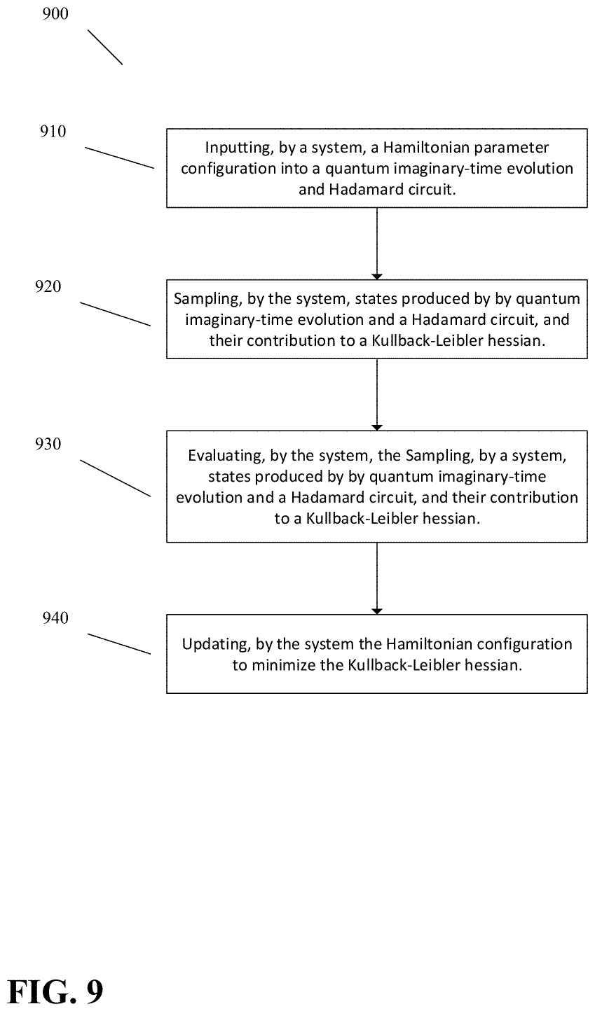

FIG. 9 illustrates a flow diagram of an example, non-limiting computer-implemented method 900 that can facilitate training of quantum Boltzmann machines by quantum imaginary-time evolution in accordance with one or more embodiments described herein.

At 910, computer-implemented method 900 can comprise inputting, by a system (e.g., imaginary-time evolution training system 201 and/or input component 306) operatively coupled to a processor (e.g., processor 203), a Hamiltonian parameter configuration into a quantum imaginary time-evolution and a Hadamard circuit. For example, as described above in reference to FIGS. 2 and 3, input component 306 can receive a Hamiltonian and a set of input parameters. Input component 306 can then signal quantum system 101 to prepare two qubit registers using the equilibrium state of the parameterized Hamiltonian and to prepare a Hadamard circuit to use to perform imaginary-time evolutions. In an embodiment, a quantum simulator can be used to perform the functions of quantum system 101.

At 920, computer-implemented method 900 can comprise sampling, by the system (e.g., imaginary-time evolution training system 201 and/or sampling component 305), states produced by quantum imaginary-time evolution and a Hadamard circuit, and their contribution to a Kullback-Leibler divergence. For example, as described in reference to FIGS. 2 and 3, sampling component 305 can take three samples, ν, x, and h, wherein ν is a visible sample state taken from the training set, x is sample of a dummy integration variable, and h is a hidden sample state taken from the trained model.

At 930, computer-implemented method 900 can comprise evaluating, by the system (e.g., imaginary-time evolution training system 201 and/or evaluation component 204), the sampling produced by quantum imaginary-time evolution and a Hadamard circuit, and their contribution to a Kullback-Leibler divergence hessian. For example, as described above in detail in reference to FIGS. 2 and 3, evaluation component 204 can evaluate the Kullback-Leibler divergence hessian using the formula:

∂_{λ}_{^{ρ}}_{λ}_{^{μ}}D(λ)=E[h_{ρ}]E[h_{μ}]−∫₀¹dxE[h_{ρ}(x)h_{μ}]+∫₀¹dx∫₀dyΣ_{ν}Q(ν){E_{ν}[h_{ρ}(xy)h_{μ}(x)]−x E_{ν}[h_{μ}(x)]E_{ν}[h_{ρ}(y)]},

wherein E denotes thermal averaging, λ denotes the parameter configuration, ν is a visible sample state, x is a dummy integration variable, h is a hidden sample state, state, y is a second dummy integration variable, H_{λ} denotes a Hamiltonian, and

$${E}_{v} [ X ] = \frac{E [ ( \vert v 〉 ( v \vert ⊗ I ) {Xe}^{- {H}_{λ}} ]}{E [ ( \vert v 〉 ( v \vert ⊗ I ) {e}^{- {H}_{λ}} ]} .$$

At 940, computer-implemented method 900 can comprise updating, by the system (e.g., imaginary-time evolution training system 201 and/or update component 307), the Hamiltonian configuration to minimize the Kullback-Leibler divergence hessian.

It should be appreciated that imaginary-time evolution training system 201 can provide technical improvements to a processing unit associated with imaginary-time evolution training system 201 and/or quantum system 101. For example, by training a quantum system to perform as a Boltzmann machine, complex machine learning tasks can be performed faster and/or more accurately than with a classical model, thereby reducing the workload of such a processing unit (e.g., processor 203) and/or quantum system 101. In these examples, by reducing the workload of such a processing unit (e.g., processor 203) and/or quantum system 101, imaginary-time evolution training system 201 can thereby facilitate improved performance, improved efficiency, and/or reduced computational cost associated with such a processing unit.

Imaginary-time evolution training system 201 can employ hardware and or software to solve problems that are highly technical in nature, that are not abstract and that cannot be performed as a set of mental acts by a human. In some embodiments, one or more processes described herein can be performed by one or more specialized quantum computers (e.g., a specialized processing unit, a specialized classical computer, a specialized quantum computer, and/or another type of specialized computer) to execute defined tasks related to the various technologies identified above. Imaginary-time evolution training system 201, and/or components thereof, can be employed to solve new problems that arise through advancements in employment of quantum computing systems, machine learning, cloud computing system, computer architecture, and/or another technology.

It is to be appreciated that imaginary-time evolution training system 201 can utilize various combinations of electrical components, mechanical components, and circuitry that cannot be replicated in the mind of a human or performed by a human, as the various operations that can be executed by imaginary-time evolution training system 201 and/or components thereof as described herein are operations that are greater than the capability of a human mind. For instance, the amount of data processed, the speed of processing such data, or the types of data processed by imaginary-time evolution training system 201 over a certain period of time can be greater, faster, or different that the amount, speed, or data type that can be processed by a human mind over the same period of time. In another example, a human, or even thousands of humans, cannot efficiently, accurately and/or effectively execute one or more quantum programs in the time that one or more embodiments described herein can facilitate this process. And, neither can the human mind nor a human with pen and paper electronically execute quantum programs as conducted by one or more embodiments described herein.

According to several embodiments, imaginary-time evolution training system 201 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that imaginary-time evolution training system 201 can include information that is impossible to obtain manually by an entity, such as a human user.

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

FIG. 10 and the following discussion are intended to provide a brief, general description of a suitable operating environment 1000 in which one or more embodiments described herein can be implemented. For example, one or more components and/or other aspects of embodiments described herein can be implemented in or be associated with, such as accessible via, the operating environment 1000. Further, while one or more embodiments have been described above in the general context of computer-executable instructions that can run on one or more computers, those skilled in the art will recognize that one or more embodiments also can be implemented in combination with other program modules and/or as a combination of hardware and software.

Generally, program modules include routines, programs, components, data structures and/or the like, that perform particular tasks and/or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and/or the like, each of which can be operatively coupled to one or more associated devices.

Computing devices typically include a variety of media, which can include computer-readable storage media, machine-readable storage media and/or communications media, which two terms are used herein differently from one another as follows. Computer-readable storage media or machine-readable storage media can be any available storage media that can be accessed by the computer and includes both volatile and nonvolatile media, removable and non-removable media. By way of example, but not limitation, computer-readable storage media and/or machine-readable storage media can be implemented in connection with any method or technology for storage of information such as computer-readable and/or machine-readable instructions, program modules, structured data and/or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) and/or other optical disk storage, magnetic cassettes, magnetic tape, magnetic disk storage and/or other magnetic storage devices, solid state drives or other solid state storage devices and/or other tangible and/or non-transitory media which can be used to store specified information. In this regard, the terms “tangible” or “non-transitory” herein as applied to storage, memory and/or computer-readable media, are to be understood to exclude only propagating transitory signals per se as modifiers and do not relinquish rights to all standard storage, memory and/or computer-readable media that are not only propagating transitory signals per se.

Computer-readable storage media can be accessed by one or more local or remote computing devices, e.g., via access requests, queries and/or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, but not limitation, communication media can include wired media, such as a wired network, direct-wired connection and/or wireless media such as acoustic, RF, infrared and/or other wireless media.

With reference again to FIG. 10, the example operating environment 1000 for implementing one or more embodiments of the aspects described herein can include a computer 1002, the computer 1002 including a processing unit 1006, a system memory 1004 and/or a system bus 1008. It will be appreciated that one or more aspects of the processing unit 1006 can be applied to processors such as 106 of the non-limiting system 100. It also will be appreciated that the processing unit 1006 can be implemented in combination with and/or alternatively to processors such as 106.

Memory 1004 can store one or more computer and/or machine readable, writable and/or executable components and/or instructions that, when executed by processing unit 1006 (e.g., a classical processor, a quantum processor and/or like processor), can facilitate performance of operations defined by the executable component(s) and/or instruction(s). For example, memory 1004 can store computer and/or machine readable, writable and/or executable components and/or instructions that, when executed by processing unit 1006, can facilitate execution of the one or more functions described herein relating to non-limiting system 100, as described herein with or without reference to the one or more figures of the one or more embodiments.

Memory 1004 can comprise volatile memory (e.g., random access memory (RAM), static RAM (SRAM), dynamic RAM (DRAM) and/or the like) and/or non-volatile memory (e.g., read only memory (ROM), programmable ROM (PROM), electrically programmable ROM (EPROM), electrically erasable programmable ROM (EEPROM) and/or the like) that can employ one or more memory architectures.

Processing unit 1006 can comprise one or more types of processors and/or electronic circuitry (e.g., a classical processor, a quantum processor and/or like processor) that can implement one or more computer and/or machine readable, writable and/or executable components and/or instructions that can be stored at memory 1004. For example, processing unit 1006 can perform one or more operations that can be specified by computer and/or machine readable, writable and/or executable components and/or instructions including, but not limited to, logic, control, input/output (I/O), arithmetic and/or the like. In one or more embodiments, processing unit 1006 can be any of one or more commercially available processors. In one or more embodiments, processing unit 1006 can comprise one or more central processing unit, multi-core processor, microprocessor, dual microprocessors, microcontroller, System on a Chip (SOC), array processor, vector processor, quantum processor and/or another type of processor. The examples of processing unit 1006 can be employed to implement one or more embodiments described herein.

The system bus 1008 can couple system components including, but not limited to, the system memory 1004 to the processing unit 1006. The system bus 1008 can comprise one or more types of bus structure that can further interconnect to a memory bus (with or without a memory controller), a peripheral bus and/or a local bus using one or more of a variety of commercially available bus architectures. The system memory 1004 can include ROM 1010 and/or RAM 1012. A basic input/output system (BIOS) can be stored in a non-volatile memory such as ROM, erasable programmable read only memory (EPROM) and/or EEPROM, which BIOS contains the basic routines that help to transfer information among elements within the computer 1002, such as during startup. The RAM 1012 can include a high-speed RAM, such as static RAM for caching data.

The computer 1002 can include an internal hard disk drive (HDD) 1014 (e.g., EIDE, SATA), one or more external storage devices 1010 (e.g., a magnetic floppy disk drive (FDD), a memory stick or flash drive reader, a memory card reader and/or the like) and/or a drive 1020, e.g., such as a solid state drive or an optical disk drive, which can read or write from a disk 1022, such as a CD-ROM disc, a DVD, a BD and/or the like. Additionally, and/or alternatively, where a solid state drive is involved, disk 1022 could not be included, unless separate. While the internal HDD 1014 is illustrated as located within the computer 1002, the internal HDD 1014 can also be configured for external use in a suitable chassis (not shown). Additionally, while not shown in operating environment 1000, a solid state drive (SSD) can be used in addition to, or in place of, an HDD 1014. The HDD 1014, external storage device(s) 1010 and drive 1020 can be connected to the system bus 1008 by an HDD interface 1024, an external storage interface 1026 and a drive interface 1028, respectively. The HDD interface 1024 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, can also be used in the example operating environment, and/or that any such storage media can contain computer-executable instructions for performing the methods described herein.

A number of program modules can be stored in the drives and RAM 1012, including an operating system 1030, one or more applications 1032, other program modules 1034 and/or program data 1036. All or portions of the operating system, applications, modules and/or data can also be cached in the RAM 1012. The systems and/or methods described herein can be implemented utilizing one or more commercially available operating systems and/or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In a related embodiment, operating system 1030 can comprise one virtual machine (VM) of multiple VMs hosted at computer 1002. Furthermore, operating system 1030 can provide runtime environments, such as the JAVA runtime environment or the .NET framework, for applications 1032. Runtime environments are consistent execution environments that can allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and/or settings for an application.

Further, computer 1002 can be enabled with a security module, such as a trusted processing module (TPM). For instance, with a TPM, boot components hash next in time boot components and wait for a match of results to secured values before loading a next boot component. This process can take place at any layer in the code execution stack of computer 1002, e.g., applied at application execution level and/or at operating system (OS) kernel level, thereby enabling security at any level of code execution.

An entity can enter and/or transmit commands and/or information into the computer 1002 through one or more wired/wireless input devices, e.g., a keyboard 1038, a touch screen 1040 and/or a pointing device, such as a mouse 1042. Other input devices (not shown) can include a microphone, an infrared (IR) remote control, a radio frequency (RF) remote control and/or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint and/or iris scanner, and/or the like. These and other input devices can be connected to the processing unit 1006 through an input device interface 1044 that can be coupled to the system bus 1008, but can be connected by other interfaces, such as a parallel port, an IEEE 1094 serial port, a game port, a USB port, an IR interface, a BLUETOOTH® interface and/or the like.

A monitor 1046 or other type of display device can be alternatively and/or additionally connected to the system bus 1008 via an interface, such as a video adapter 1048. In addition to the monitor 1046, a computer typically includes other peripheral output devices (not shown), such as speakers, printers and/or the like.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device and/or other common network node, and typically includes many or all of the elements described relative to the computer 1002, although, for purposes of brevity, only a memory/storage device 1052 is illustrated. Additionally, and/or alternatively, the computer 1002 can be coupled (e.g., communicatively, electrically, operatively, optically and/or the like) to one or more external systems, sources and/or devices (e.g., classical and/or quantum computing devices, communication devices and/or like device) via a data cable (e.g., High-Definition Multimedia Interface (HDMI), recommended standard (RS) 232, Ethernet cable and/or the like).

In one or more embodiments, a network can comprise one or more wired and/or wireless networks, including, but not limited to, a cellular network, a wide area network (WAN) (e.g., the Internet), or a local area network (LAN). For example, one or more embodiments described herein can communicate with one or more external systems, sources and/or devices, for instance, computing devices (and vice versa) using virtually any specified wired or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol and/or other proprietary and/or non-proprietary communication protocols. In a related example, one or more embodiments described herein can include hardware (e.g., a central processing unit (CPU), a transceiver, a decoder, quantum hardware, a quantum processor and/or the like), software (e.g., a set of threads, a set of processes, software in execution, quantum pulse schedule, quantum circuit, quantum gates and/or the like) and/or a combination of hardware and/or software that facilitates communicating information among one or more embodiments described herein and external systems, sources and/or devices (e.g., computing devices, communication devices and/or the like).

The logical connections depicted include wired/wireless connectivity to a local area network (LAN) 1054 and/or larger networks, e.g., a wide area network (WAN) 1056. LAN and WAN networking environments can be commonplace in offices and companies and can facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired and/or wireless communication to the LAN 1054, which can also include a wireless access point (AP) disposed thereon for communicating with the adapter 1058 in a wireless mode.

When used in a WAN networking environment, the computer 1002 can include a modem 1060 and/or can be connected to a communications server on the WAN 1056 via other means for establishing communications over the WAN 1056, such as by way of the Internet. The modem 1060, which can be internal and/or external and a wired and/or wireless device, can be connected to the system bus 1008 via the input device interface 1044. In a networked environment, program modules depicted relative to the computer 1002 or portions thereof can be stored in the remote memory/storage device 1052. It will be appreciated that the network connections shown are merely exemplary and one or more other means of establishing a communications link among the computers can be used.

When used in either a LAN or WAN networking environment, the computer 1002 can access cloud storage systems or other network-based storage systems in addition to, and/or in place of, external storage devices 1010 as described above, such as but not limited to, a network virtual machine providing one or more aspects of storage and/or processing of information. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, such as with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices and/or entities operatively disposed in wireless communication, e.g., a printer, scanner, desktop and/or portable computer, portable data assistant, communications satellite, telephone and/or any piece of equipment or location associated with a wirelessly detectable tag (e.g., a kiosk, news stand, store shelf and/or the like). This can include Wireless Fidelity (Wi-Fi) and BLUETOOTH® wireless technologies. Thus, the communication can be a predefined structure as with a conventional network or simply an ad hoc communication between at least two devices.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented in combination with one or more other program modules. Generally, program modules include routines, programs, components, data structures and/or the like that perform particular tasks and/or implement particular abstract data types. Moreover, those skilled in the art will appreciate that the inventive computer-implemented methods can be practiced with other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

The claims and scope of the subject application, and any continuation, divisional or continuation-in-part applications claiming priority to the subject application, exclude embodiments (e.g., systems, apparatus, methodologies, computer program products and computer readable storage media) directed to implanted electrical stimulation for pain treatment and/or management.

What is claimed is:

1. A computer-implemented method, comprising:
evaluating, by a system operatively coupled to a processor, a Kullback-Leibler divergence gradient by a sampling procedure, where samples are generated by quantum imaginary-time evolution and a Hadamard circuit.

2. The computer-implemented method of claim 1, further comprising:
sampling, by the system, states produced by quantum imaginary-time evolution and the Hadamard circuit, and their contribution to the Kullback-Leibler divergence gradient.

3. The computer-implemented method of claim 1, further comprising:
inputting, by the system, a Hamiltonian parameter configuration into the quantum imaginary-time evolution and the Hadamard circuit.

4. The computer-implemented method of claim 3, further comprising:
updating, by the system, the Hamiltonian parameter configuration to minimize the Kullback-Leibler divergence gradient.

5. The computer-implemented method of claim 1, wherein the Kullback-Leibler divergence gradient is evaluated as:
$${\partial }_{{λ}^{μ}} D ( λ ) = E [ {\partial }_{{λ}^{μ}} {H}_{λ} ] - {\int }_{0}^{1} d x {\sum }_{v} Q ( v ) \frac{E [ ( \vert v 〉 〈 v \vert ⊗ I ) {e}^{- x {H}_{λ}} {\partial }_{{λ}^{μ}} {H}_{λ} {e}^{( x - 1 ) {H}_{λ}} ]}{E [ ( \vert v 〉 〈 v \vert ⊗ I ) {e}^{- {H}_{λ}} ]}$$
wherein E denotes thermal averaging, λ denotes the parameter configuration, ν is a visible sample state, x is a sample of a dummy integration variable, h is a hidden sample state, and H_{λ} denotes a Hamiltonian with parameters λ.

6. The computer-implemented method of claim 1, further comprising:
evaluating, by the system, a Kullback-Leibler divergence hessian of the sample states.

7. The computer-implemented method of claim 6, wherein the Kullback-Leibler divergence hessian is evaluated as:
$${\partial }_{{λ}^{ρ} {λ}^{μ}} D ( λ ) = E [ {h}_{ρ} ] E [ {h}_{μ} ] - {\int }_{0}^{1} d x E [ {h}_{ρ} ( x ) {h}_{μ} ] + {\int }_{0}^{1} d x {\int }_{0}^{1} d y {\sum }_{v} Q ( v ) \{ {E}_{v} [ {h}_{ρ} ( x y ) {h}_{μ} ( x ) ] - x {E}_{v} [ {h}_{μ} ( x ) ] {E}_{v} [ {h}_{ρ} ( y ) ] \}$$
wherein E denotes thermal averaging, Δ denotes the parameter configuration, ν is a first sample state, x is a dummy integration variable, h is a third sample state, y is a second dummy integration variable, H_{λ} denotes a Hamiltonian, and
$${E}_{v} [ X ] = \frac{E [ ( \vert v 〉 ( v \vert ⊗ I ) {Xe}^{- {H}_{λ}} ]}{E [ ( \vert v 〉 ( v \vert ⊗ I ) {e}^{- {H}_{λ}} ]} .$$

8. A system comprising:
a memory that stores computer executable components;
a processor that executes computer executable components stored in memory, wherein
the computer executable components comprise:
an evaluation component that evaluates a Kullback-Leibler divergence gradient by a sampling procedure, where samples are generated by quantum imaginary-time evolution and a Hadamard circuit.

9. The system of claim 8, further comprising:
a sampling component that samples states produced by quantum imaginary-time evolution and the Hadamard circuit, and their contribution to the Kullback-Leibler divergence gradient.

10. The system of claim 8, further comprising:
an input component that inputs a Hamiltonian parameter configuration into the quantum imaginary-time evolution and the Hadamard circuit.

11. The system of claim 10, further comprising:
an update component that updates the Hamiltonian parameter configuration to minimize the Kullback-Leibler divergence gradient.

12. The system of claim 8, wherein the Kullback-Leibler divergence gradient is evaluated as:
$${\partial }_{{λ}^{μ}} D ( λ ) = E [ {\partial }_{{λ}^{μ}} {H}_{λ} ] - {\int }_{0}^{1} d x {\sum }_{v} Q ( v ) \frac{E [ ( \vert v 〉 〈 v \vert ⊗ I ) {e}^{- x {H}_{λ}} {\partial }_{{λ}^{μ}} {H}_{λ} {e}^{( x - 1 ) {H}_{λ}} ]}{E [ ( \vert v 〉 〈 v \vert ⊗ I ) {e}^{- {H}_{λ}} ]}$$
wherein E denotes thermal averaging, λ denotes the parameter configuration, ν is a visible sample state, x is a sample of a dummy integration variable, h is a hidden sample state, and H_{λ} denotes a Hamiltonian with parameters λ.

13. The system of claim 8, wherein the evaluation component evaluates a Kullback-Leibler divergence hessian of the sample states.

14. The system of claim 13, wherein the Kullback-Leibler divergence hessian is evaluated as:
$${\partial }_{{λ}^{ρ} {λ}^{μ}} D ( λ ) = E [ {h}_{ρ} ] E [ {h}_{μ} ] - {\int }_{0}^{1} d x E [ {h}_{ρ} ( x ) {h}_{μ} ] + {\int }_{0}^{1} d x {\int }_{0}^{1} d y {\sum }_{v} Q ( v ) \{ {E}_{v} [ {h}_{ρ} ( x y ) {h}_{μ} ( x ) ] - x {E}_{v} [ {h}_{μ} ( x ) ] {E}_{v} [ {h}_{ρ} ( y ) ] \}$$
wherein E denotes thermal averaging, λ denotes the parameter configuration, ν is a first sample state, x is a dummy integration variable, h is a third sample state, y is a second dummy integration variable, H_{λ} denotes a Hamiltonian, and
$${E}_{v} [ X ] = \frac{E [ ( \vert v 〉 ( v \vert ⊗ I ) {Xe}^{- {H}_{λ}} ]}{E [ ( \vert v 〉 ( v \vert ⊗ I ) {e}^{- {H}_{λ}} ]} .$$

15. A computer program product, the computer program product comprising one or more computer readable storage medium having program instructions embodied therewith, the program instructions executable by a processor to cause the processor to:
evaluate, by the processor, a Kullback-Leibler divergence gradient by a sampling procedure, where samples are generated by quantum imaginary-time evolution and a Hadamard circuit.

16. The computer program product of claim 15, the program instructions further executable by the processor to cause the processor to:
sample, by the processor, states produced by quantum imaginary-time evolution and the Hadamard circuit, and their contribution to the Kullback-Leibler divergence gradient.

17. The computer program product of claim 15, the program instructions further executable by the processor to cause the processor to:
input, by the processor, a Hamiltonian parameter configuration into the quantum imaginary-time evolution and the Hadamard circuit.

18. The computer program product of claim 17, the program instructions further executable by the processor to cause the processor to:
update, by the processor, the Hamiltonian parameter configuration to minimize the Kullback-Leibler divergence gradient.

19. The computer program product of claim 15, wherein the Kullback-Leibler divergence gradient is evaluated as:
$${\partial }_{{λ}^{μ}} D ( λ ) = E [ {\partial }_{{λ}^{μ}} {H}_{λ} ] - {\int }_{0}^{1} d x {\sum }_{v} Q ( v ) \frac{E [ ( \vert v 〉 〈 v \vert ⊗ I ) {e}^{- x {H}_{λ}} {\partial }_{{λ}^{μ}} {H}_{λ} {e}^{( x - 1 ) {H}_{λ}} ]}{E [ ( \vert v 〉 〈 v \vert ⊗ I ) {e}^{- {H}_{λ}} ]}$$
wherein E denotes thermal averaging, λ denotes the parameter configuration, ν is a visible sample state, x is a sample of a dummy integration variable, h is a hidden sample state, and H_{λ} denotes a Hamiltonian with parameters λ.

20. The computer program product of claim 15, the program instructions further executable by the processor to cause the processor to: evaluate, by the processor, a Kullback-Leibler divergence hessian of the sample states.
